(19) United States
(12) Patent Application Publication
(10) Pub. No.: US 2026/0340355 A1
(43) Pub. Date: Oct. 29, 2026

(54) POSE CORRELATION BASED DIGITAL VIDEO GENERATION

(71) Applicant: Adobe Inc., San Jose, CA (US)

(72) Inventors: Zhan Xu, San Jose, CA (US); Zhixin Shu, San Jose, CA (US); Yang Zhou, Mountain View, CA (US); Fating Hong, Zhanjiang (CN); Duygu Ceylan Aksit, London (GB)

(73) Assignee: Adobe Inc., San Jose, CA (US)

(21) Appl. No.: 19/185,778

(22) Filed: Apr. 22, 2025

(51) Int. Cl. G06N 3/0475; G06T 5/60; G06T 5/70; G06T 7/70; G06V 20/40

(52) U.S. Cl. CPC G06N 3/0475; G06T 5/60; G06T 5/70; G06T 7/70; G06T 13/40; G06V 10/7715; G06V 20/41

(57) ABSTRACT

Pose correlation based digital video generation is described. A plurality of reference digital images depicting a reference object and a plurality of target pose digital images depicting a target object are received. Reference features from the plurality of reference digital images and target features from the plurality of target pose digital images are extracted using one or more machine-learning models. A pose correlation map is computed, using the one or more machine-learning models, based on reference poses of the reference object from the plurality of reference digital images and target poses of the target object from the plurality of target pose digital images. A digital video is generated having a plurality of frames based on the reference features, the target features, and the pose correlation map and presented for display in a user interface.

### BACKGROUND

Digital video generation involves synthesizing digital video using computing devices. Digital video generation is usable to support a wide variety of usage scenarios such as animations, generation of “realistic” digital videos that mimic a view of the “real world,” scenes in video games, and so forth. To do so, a diffusion machine-learning model may be employed to learn to denoise data, starting with random noise and refining the data into a series of frames in order to generate the digital video.

However, technical challenges are common in conventional digital video generation techniques in maintaining temporal coherence between the frames. These technical challenges often result in visual inaccuracies, such as to maintain temporal coherence in movement of an object between frames of the digital video. These visual inaccuracies are readily noticeable by a human as visual artifacts, such as jittering, missing pieces of an object, unrealistic movements, and so forth. These technical challenges are further exacerbated in generating digital videos that involve significant changes in viewpoints, significant changes in camera distance (i.e., a “zoom level”), and so forth between frames of the digital video.

### SUMMARY

Pose correlation based digital video generation techniques are described. In one or more examples, these techniques employ a diffusion machine-learning model that supports viewpoint changes and camera-to-object distance variations with improved accuracy and reduced visual artifacts. To do so, a pose correlation map is generated based on reference poses from reference digital images and target poses from target pose digital images. The pose correlation map is usable to guide the diffusion machine-learning model to selectively focus on relevant spatial locations in reference feature maps. This approach enables incorporation of visual information from multiple reference images without excessive computational costs, improving efficiency and enabling the generation of temporally coherent digital videos with increased realism, particularly in scenarios involving significant viewpoint or distance changes that are challenging for conventional techniques.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ pose correlation based digital video generation techniques described herein.

FIG. 2 depicts a system in an example implementation showing operation of the digital video generation system of FIG. 1 in greater detail as generating training data and using the training data to train a machine-learning model configured as a diffusion machine-learning model.

FIG. 3 is a flow diagram depicting a step-by-step procedure in an example implementation of operations performable by a processing device for accomplishing a result of training data generation to train a machine-learning model to generate a digital video.

FIG. 4 depicts a system in an example implementation showing operation of the digital video generation system as generating a digital video based on reference digital images and target pose digital images using a pose correlation map.

FIG. 5 depicts a system in an example implementation showing operation of a pose correlation module of FIG. 4 in greater detail as generating a pose correlation map.

FIG. 6 is a flow diagram depicting a step-by-step procedure in an example implementation of operations performable by a processing device for accomplishing a result of digital video generation based on pose correlation.

FIG. 7 shows an example of a guided diffusion model according to aspects of the present disclosure.

FIG. 8 shows an example of a U-Net according to aspects of the present disclosure.

FIG. 9 shows an example of a method for conditional media generation according to aspects of the present disclosure.

FIG. 10 shows a diffusion process according to aspects of the present disclosure.

FIG. 11 is a flow diagram depicting an algorithm as a step-by-step procedure in an example implementation of operations performable for training a machine-learning model.

FIG. 12 shows an example of a method for training a diffusion model according to aspects of the present disclosure.

FIG. 13 illustrates an example system including various components of an example device that can be implemented as any type of computing device as described and/or utilize with reference to FIGS. 1-12 to implement embodiments of the techniques described herein.

### DETAILED DESCRIPTION

### Overview

Digital video generation involves synthesizing a digital video through use of one or more computing devices, e.g., by using a machine-learning model that implements generative artificial intelligence (AI). Digital video generation is usable to support a wide variety of usage scenarios such as animations, generation of “realistic” digital videos that mimic a view of the “real world,” for use in video games, social media graphics, and so forth.

Conventional techniques for reference-based digital video generation, however, typically utilize a single reference digital image to provide an object's appearance (e.g., of a human), while representing a motion sequence as a series of skeletal poses of the human. Although advances have been made to improve quality and robustness, technical challenges remain in maintaining temporal coherence when generating a digital video that involve significant changes between a viewpoint (i.e., “camera position”) and the object being depicted in the frames of the digital video, e.g., a human being.

Conventional techniques, for example, are primarily limited to digital video generation using a single viewpoint as that employed by a reference digital image. Further, conventional techniques typically assume a fixed camera-to-object distance (i.e., zoom level), thereby restricting generation to a same camera-to-object distance as that employed by the reference digital image. As such, conventional techniques are faced with technical challenges in generating digital video that support changes in viewpoint or camera-to-object distance between frames of the digital image, e.g., that differ from reference digital images of an object to be depicted in the frames of the digital video.

Accordingly, pose correlation based digital video generation techniques are described in the following discussion as a technical solution to address these and other technical challenges in digital video generation using machine learning. A digital video generation system, for instance, is configurable to employ a machine-learning model (e.g., a diffusion machine-learning model) that supports viewpoint changes (e.g., panning a view across a plurality of viewpoints), changes in a camera-to-object distance (i.e., “zoom level”), and so forth. The digital video generation system is configured to support this functionality with improved accuracy with a reduction in visual artifacts when compared with conventional techniques as well as increased efficiency in use of computational resources as compared with conventional techniques.

To do so, a pose correlation map is generated as a guide for use by a diffusion machine-learning model in generating the digital video. The pose correlation map is computed in one or more examples based on reference poses extracted from reference digital images of an object (e.g., human) to be depicted in the digital video and target poses from target pose digital images that are to be employed by the object in the generated digital video. The pose correlation map is configured to quantify an amount of emphasis on respective regions within feature maps used during digital video generation, establishing informative correlations between target poses and reference poses. In this way, the diffusion machine-learning model utilizes the pose correlation map to selectively focus on spatial locations in the reference feature maps based on respective amounts of relevancy during generation of the digital video. By employing this selective technique, the diffusion machine-learning model is configured to incorporate visual information from multiple reference digital images without incurring excessive computational costs, thereby improving computing device operation and efficiency.

As a result, the pose correlation map acts to guide the diffusion machine-learning model to concentrate on visual cues from the reference digital images, particularly when managing significant viewpoint changes between frames. This approach enables a diffusion machine-learning model to generate digital videos having increased realism and that are temporally coherent, especially in scenarios involving dramatic shifts in viewpoints or distances that are challenging for conventional techniques.

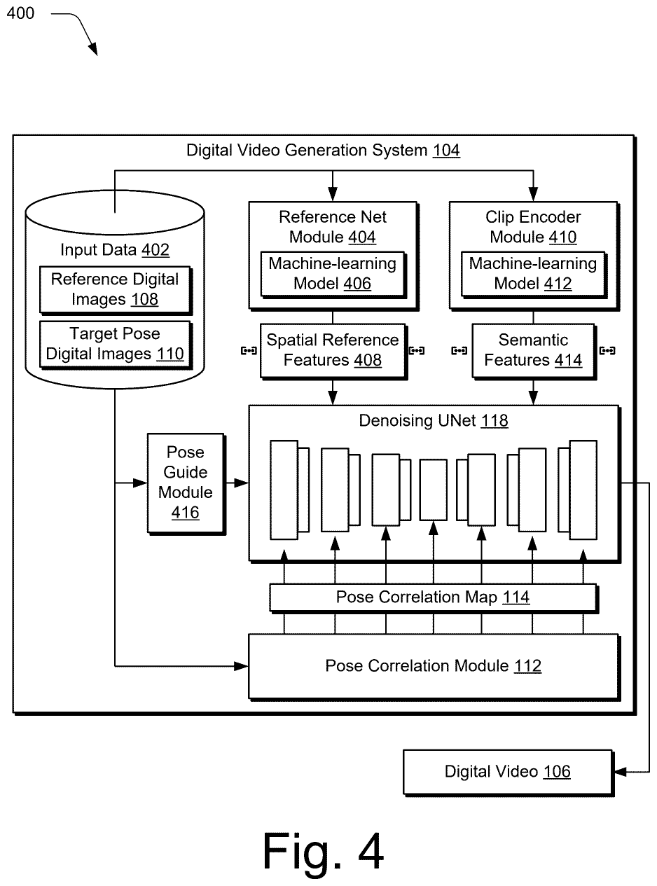

The digital video generation system, for instance, is configurable to receive as an input a full-body reference digital image and from this synthesize one or more digital images as frames of a digital video, e.g., as a close-up video shot of the character's upper body, or vice versa. As a result, the digital video generation system supports generation of an animation (e.g., of a human) that is “viewpoint-free”and supports dedicated camera control across a variety of distances between a viewpoint and an object being depicted, which is not possible using conventional techniques. Further discussion of pose correlation based digital video generation may be found in relation to FIGS. 4-6 in the following discussion.

The digital video generation system is also configurable to employ training data generation techniques that are usable to train a machine-learning model (e.g., a diffusion machine-learning model) to generate a digital video. In real-world scenarios, there are a limited number of publicly available datasets that exhibit substantial variations in viewpoints and/or camera-to-object distances that are suitable to train a machine-learning model. Accordingly, the digital video generation module is configurable to address this technical challenge through generation of training data in order to train a machine-learning model to support substantial variations in viewpoints and/or camera-to-object distances.

To do so in one or more examples, the digital video generation system collects digital videos from a speaker video repository. The speaker video repository, for instance, is configurable to include digital videos from conferences, lectures, or “talks.” The digital videos exhibit an object (e.g., a human “speaker”) at different viewpoints and/or camera-to-object distances within a single “shot,” e.g., continuous sequence of frames from a particular source (e.g., camera) of a respective object such as part of a single-camera setup.

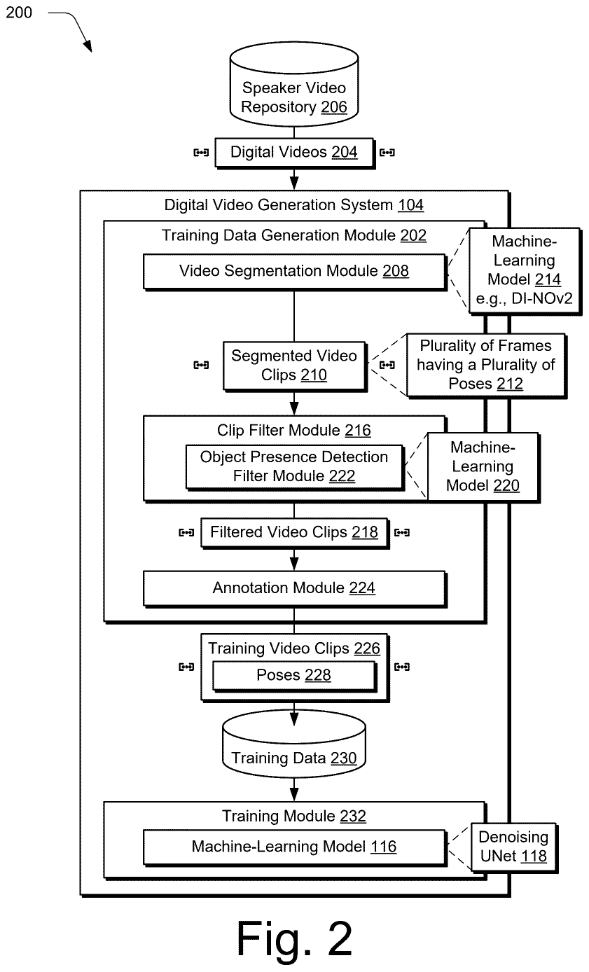

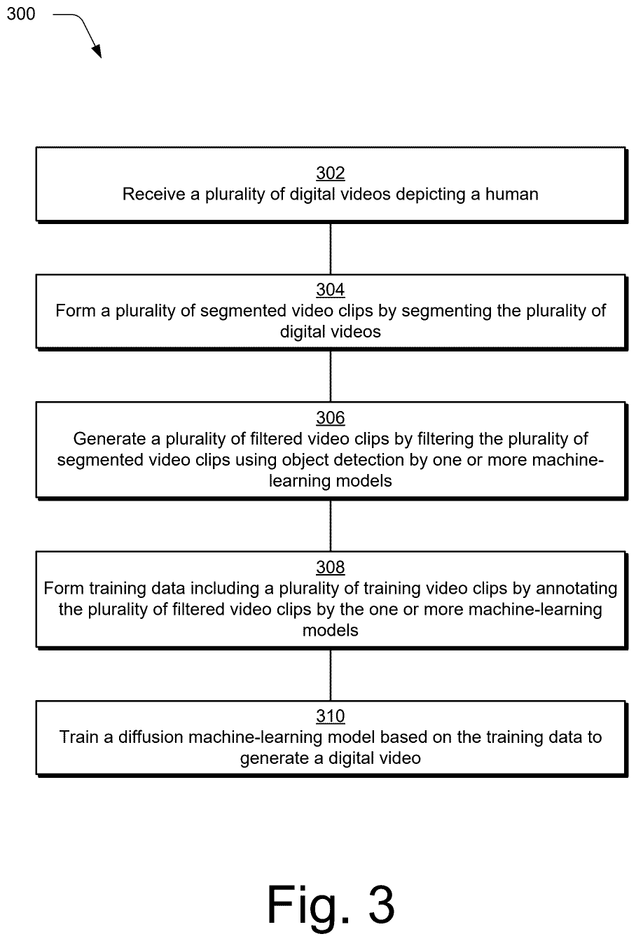

The digital video generation system then segments the videos into a plurality of segmented video clips. The digital video generation system, for instance, may use a machine-learning model to form the segmented video clips based on similarity of frames of the digital videos to each other, frames corresponding to a single “shot,” and so forth. A filtering technique is also leveraged based on object presence detection to filter out segmented video clips in which an object is not consistently present, includes multiple primary subjects, and so forth. In this way, a set of filtered video clips is formed, which are then annotated to identify poses that are then used to form the training data used to train the machine-learning model to perform digital video generation. The machine-learning model, once trained, is thereafter usable to implement the pose correlation based digital video generation as described above. Further discussion of training data generation may be found in relation to FIGS. 2 and 3 in the following discussion.

### TERM EXAMPLES

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

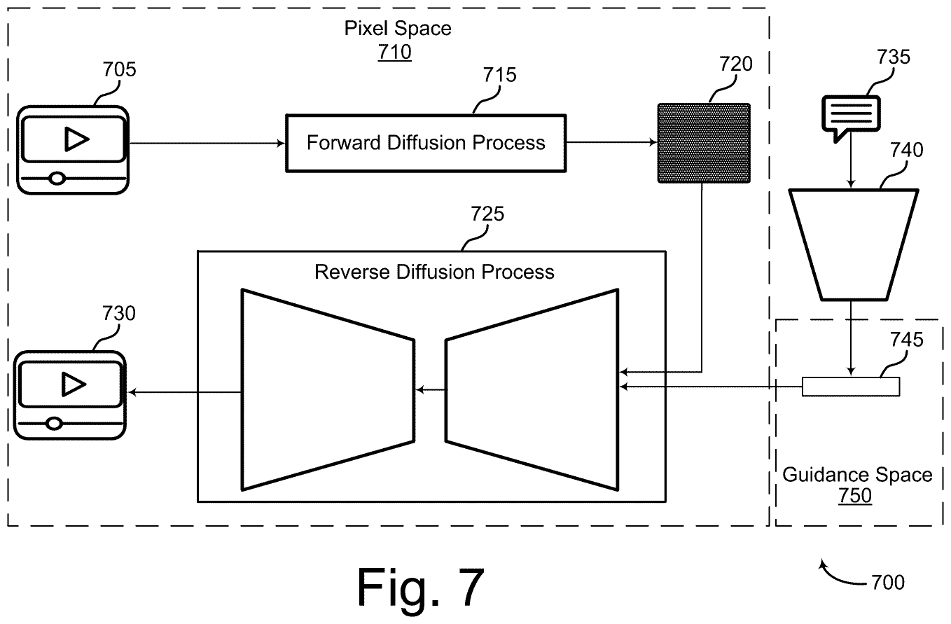

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt. Further discussion of use of diffusion models may be found in relation to FIGS. 7-12.

In the following discussion, an example pose correlation environment is described that employs the techniques described herein. Example procedures are also described that are performable in the example environment as well as other environments. Consequently, performance of the example procedures is not limited to the example environment and the example environment is not limited to performance of the example procedures.

### Example Pose Correlation Based Digital Video Environment

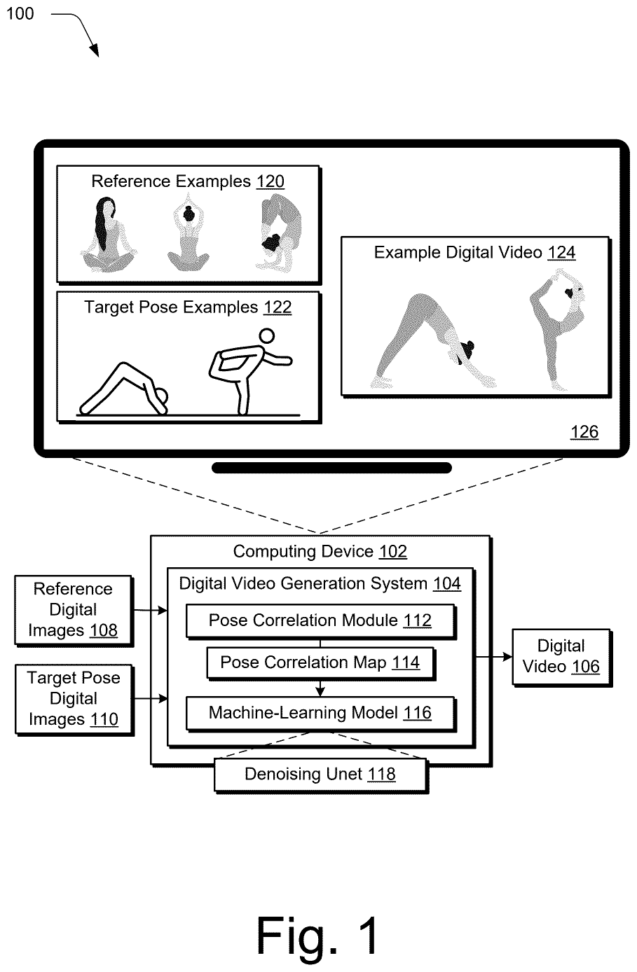

FIG. 1 is an illustration of a digital medium environment 100 in an example implementation that is operable to employ pose correlation based digital video generation techniques described herein. The illustrated environment 100 includes a computing device 102. Computing devices are configurable in a variety of ways.

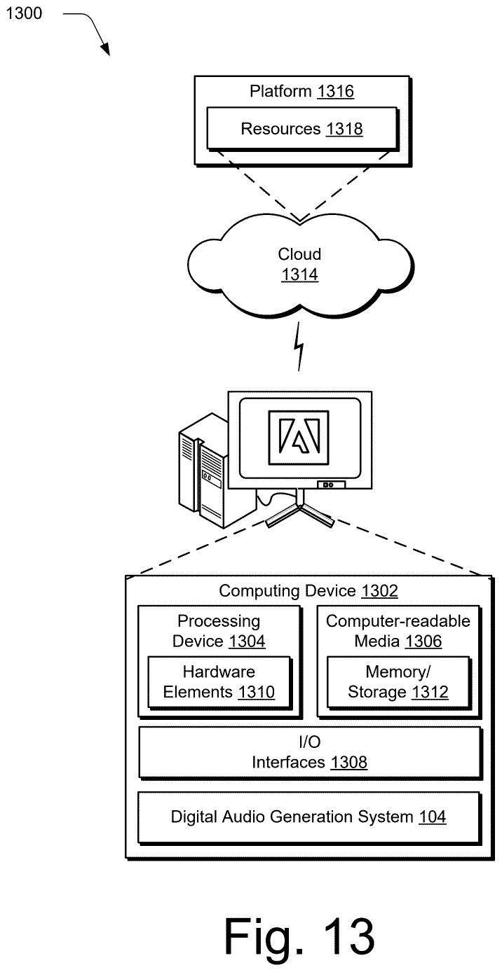

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” as further described in relation to FIG. 13.

The computing device 102, as illustrated, includes a digital video generation system 104 that is configured to generate a digital video 106. A digital video 106 is configurable in a variety of ways. A digital video 106, for instance, is configurable as a plurality of frames in a digital form that are usable to exhibit motion of an object, e.g., as an animation, in a video game, as mimicking a “real world” scene, for use in a video game, animate a user's face as part of an emoji, and so forth. Digital video 106 may encompass various digital formats as well as various digital image formats that form frames of the digital video 106. Although functionality of the digital video generation system 104 is illustrated as implemented locally at a computing device 102, this functionality may also be implemented remotely (e.g., as a digital service executed by a digital service provider system) via a network.

In order to generate the digital video 106, the digital video generation system 104 receives as an input reference digital images 108 depicting a visual appearance of a reference object that is to be a subject of the digital video 106. The digital video generation system 104 also receives as an input target pose digital images 110 depicting target poses (e.g., orientations and positions of respective parts) of a target object that are to be mimicked by the reference object.

The reference digital images 108 and target pose digital images 110, for instance, are processed by a pose correlation module to generate a pose correlation map 114. The pose correlation map 114 maps reference poses of a reference object in the reference digital images 108 with target poses of a target object of the target pose digital images 110. The pose correlation map 114 is configured to cause the machine-learning model 116 (e.g., configured as a denoising UNet as further described in relation to FIG. 4) to selectively focus on informative regions of reference digital images 108 when synthesizing new viewpoints and poses in the digital video 106. This selective approach allows incorporation of visual information from multiple reference digital images 108 without incurring excessive computational costs, thereby improving computational efficiency.

The pose correlation map 114, for instance, is configurable to indicate correlations between target poses and reference poses that are meaningful to the machine-learning model 116. These correlations act as a guide to the machine-learning model 116 in order to maintain consistent object appearance across significant viewpoint and camera-to-object distance changes in the generated digital video 106. By emphasizing visual cues from reference images, especially when managing significant perspective shifts between frames, the pose correlation map 114 enables the machine-learning model 116 to generate the digital video 106 to have increased realism as part of a temporally coherent output.

In the illustrated example, for instance, reference examples 120 are depicted in a user interface of a reference object of a woman from multiple viewpoints. The target pose examples 122 depict a target object as a stick figure in different yoga poses. An example digital video 124 is generated from these examples by the digital video generation system 104 that shows the reference object as following/mimicking movement of the target object from the target pose examples 122, e.g., as performing the yoga poses. Changes to viewpoints and camera-to-object distances are also contemplated. In this way, the pose correlation map 114 supports generation of the digital video 106 to have substantial variations in viewpoint or camera-to-object distance, which is not possible using conventional techniques.

The example as depicted in the user interface 126 of FIG. 1 involves a human animation scenario in which a reference object as a human character is animated based on a target object in a sequence of poses. Conventional techniques, as previously described, struggle when confronted with significant viewpoint changes, especially in scenarios in which a camera-to-object distance in “zoom in/zoom out” also changes. In the techniques described herein, however, the digital video generation system 104 is configured to utilize multiple reference digital images 108 as an input to address significant viewpoint changes which in conventional examples often lead to missing appearance details and other visual artifacts.

To reduce a computational cost in doing so, the pose correlation module 112 is configured to generate a pose correlation map 114 to compute similarities between unaligned target poses of a target object and reference poses of a reference objects. The machine-learning model 116 may then incorporate an adaptive reference selection strategy utilizing the pose correlation map 114 to identify key regions for generating frames of the digital video 106 that are passed between stages of the machine-learning model 116, solely, as further described below.

Reference-based human animation as depicted in the example user interface 126 of FIG. 1 involves animating a given human based on a driving motion sequence. In conventional techniques, a single reference image is used to provide the human's appearance, while the motion sequence is represented as a sequence of skeletal poses. Although recent advances have been made as previously described in quality and robustness through use of diffusion models, conventional techniques to do so primarily focus on animating the given human from a same view point as the reference digital image.

In one or more implementations, dramatic viewpoint changes reveal limitations and technical challenges in use of a single reference digital image for digital video generation. First, a single digital image is configured to capture a single viewpoint, solely, of an object and thus limits available visual information usable to generate new viewpoints. For instance, a close-up reference image of a portrait, alone, lacks lower body information that is usable to synthesize a full-body view. Likewise, a distant full-body reference image typically lacks fine-grain facial details usable to generate a high-resolution close-up image of a face. Additionally, a single-view reference often includes self-occlusions, thus large viewpoint and pose changes may reveal hidden areas of a body of the human that are not visible in the reference image.

Accordingly, in this example the digital video generation system 104 is configured to incorporate multiple viewpoints from multiple reference digital images 108 in order to achieve comprehensive visual information. To do so, the digital video generation system 104 leverages this insight by utilizing the multiple reference digital images 108 to extract rich visual details from diverse perspectives. However, directly increasing a number of reference images also leads to a linear increase in computational complexity. To mitigate against this linear increase, the digital video generation system 104 is configured to leverage a filtering technique such that rather than considering each of the spatial locations in reference feature maps passed between stages of the machine-learning model 116, a fixed number of relevant intermediate reference features are selected. This filtering technique thus supports use of an increased number of reference digital images 108 without an excessive increase in computational costs, thereby supporting enhanced realism of the generated digital video 106. In this way, the pose correlation map 114 is usable to emphasize particular regions within intermediate reference feature maps and through this emphasis guide the machine-learning model 116 to focus on particular visual cues from the reference images.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Pose Based Correlation Training Data Generation

The following discussion describes training data generation techniques for pose based correlation that are implementable utilizing the described systems and devices to train a machine-learning model to generate digital audio based on an text input and an imitation control signal. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 in an example implementation showing operation of the digital video generation system 104 of FIG. 1 in greater detail as generating training data and using the training data to train a machine-learning model configured as a diffusion machine-learning model. FIG. 3 is a flow diagram depicting a step-by-step procedure 300 in an example implementation of operations performable by a processing device for accomplishing a result of training data generation to train a machine-learning model to generate a digital video.

To begin in this example, a training data generation module 202 receives a plurality of digital videos 204 depicting a human, respectively (block 302). The plurality of digital videos 204, for instance, are received from a speaker video repository 206 having significant variations in viewpoints and camera-to-object distances. The speaker video repository 206 may include a collection of “talks” in which a speaker (human being) moves about a raised stage, a lecture, a newscast, and so forth.

A video segmentation module 208 is then employed to form a plurality of segmented video clips by segmenting the plurality of digital videos (block 304). The video segmentation module 208, for instance, may employ a machine-learning model 214 (e.g., a DI-NOv2 model) to form the segmented video clips 210 based on frame similarity corresponding to a single “shot.” A “single shot” in a digital video 204 refers to a continuous, uninterrupted take from the moment the camera starts recording until it stops. This means there are no cuts or edits within that segment.

A clip filter module 216 is then employed to generate a plurality of filtered video clips 218 by filtering the plurality of segmented video clips 210 using object detection by one or more machine-learning models (block 306), e.g., of an object presence detection filter module 222. The one or more machine-learning models 220, for instance, are configurable as a You Only Look Once (Y OLO) detector using a convolutional neural network (CNN) to perform real-time object detection to “filter out” segmented video clips 210 that do not include a subject object, e.g., a human.

The filtered video clips 218 are then annotated by an annotation module 224 to form training video clips 226 that include identification of respective poses 228 contained within the respective clips. The training video clips 226 and respective poses 228 are used as a basis to form the training data 230 (block 308). The annotation module 224, for instance, may employ one or more machine-learning models such as classified to identify respective poses within frames of the plurality of filtered video clips 218.

A training module 232 is then employed to train the machine-learning model 116 (e.g., the denoising UNet 118) based on the training data 230 to generate a digital video (block 310). The training module 232, for instance, may employ a loss function to train the denoising UNet 118 to remove noise to generate frames of the digital video as further described below.

### Example Pose Correlation Based Digital Video Generation

The following discussion describes pose correlation based digital video generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

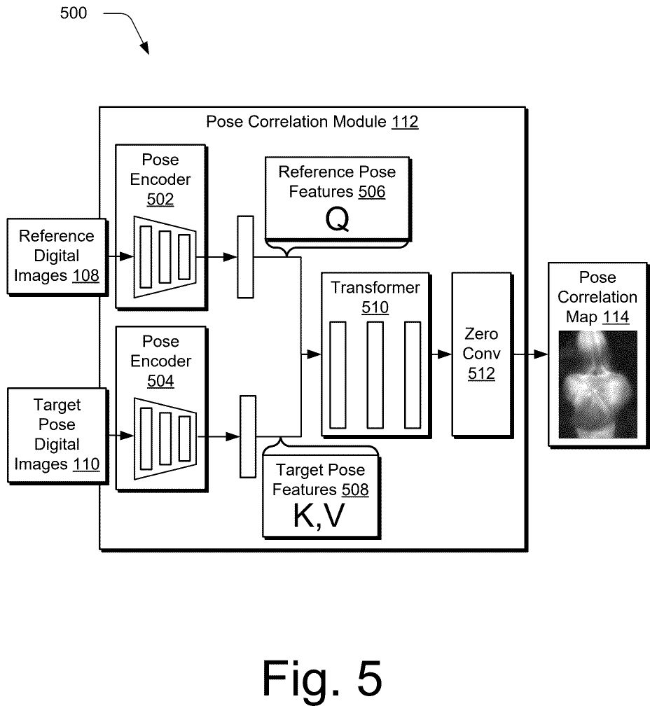

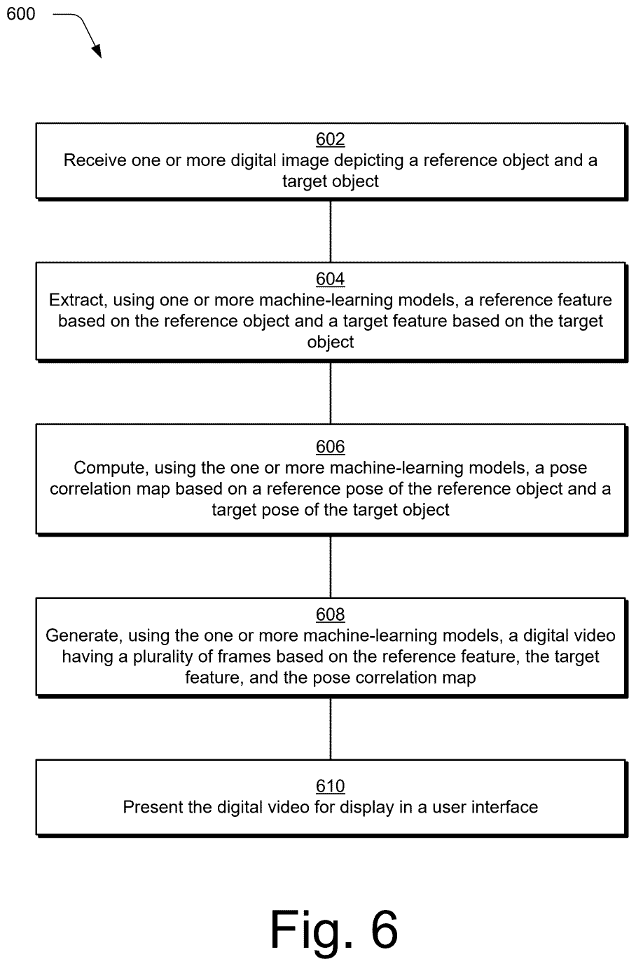

FIG. 4 depicts a system 400 in an example implementation showing operation of the digital video generation system 104 as generating a digital video 106 based on reference digital images 108 and target pose digital images 110 using a pose correlation map. FIG. 5 depicts a system 500 in an example implementation showing operation of a pose correlation module 112 of FIG. 4 in greater detail as generating a pose correlation map 114. FIG. 6 is a flow diagram depicting a step-by-step procedure 600 in an example implementation of operations performable by a processing device for accomplishing a result of digital video generation based on pose correlation.

To begin in this example, input data 402 is received by the digital video generation system 104. The input data 402 includes one or more digital images depicting a reference object and a target object (block 602). The one or more digital images, for instance, include a plurality of reference digital images 108 depicting a reference object and a plurality of target pose digital images 110 depicting a target motion of a target object, i.e., different poses of the target object.

The digital video generation system 104 then extracts a reference feature based on the reference object and a target feature based on the target object (block 602). The extracting, for instance, includes extracting reference features from the plurality of reference digital images and target features from the plurality of target pose digital images (block 604). A reference net module 404, for instance, employs a machine-learning model 406 to extract the reference features as spatial reference features 408 from the reference digital images 108. A clip encoder module 410 is also employed to process the target pose digital images 110 using a machine-learning model 412 to generate the target features as semantic features 414. The clip encoder module 410, for instance, may be configured as a contrastive language-image pretraining (CLIP) encoder.

The pose correlation map 114 is computed by a pose correlation module 112 based on the reference pose and a target poses of the target object (block 606). The pose correlation map 114 is usable as a guide for processing the reference and target pose digital images to form the digital video by the machine-learning model 116.

A digital video, for instance, is then generated as having a plurality of frames based on the reference features (e.g., the spatial reference features 408), the target features (e.g., the semantic features 414), and the pose correlation map 212 (block 608). The digital video is then presented for display in a user interface (block 610), e.g., the user interface 126 by the computing device 102.

In one or more implementations, the digital video generation system 104 employs a double UNet architecture that leverages the reference net module 404 (e.g., as a reference UNet “R”) and the clip encoder module 410, configures the machine-learning model 116 as a denoising UNet 118 “D,” and further includes a pose guide module 416 “P,” also referred to as a “pose guider.”

The denoising UNet 118 is configured to process noisy input data and generate high-quality, denoised outputs. To do so, the reference UNet “R” (as an example of the reference net module 404) extracts features from the reference digital images 108 and aggregates these extracted features into the denoising UNet 118, e.g., as the spatial reference features 408. The pose guide module 416 “P” is configured to encode target poses from the target pose digital images 110 and provide these encoding as driving conditions to the denoising UNet 118.

Therefore, given a set of reference digital images 108

$${\{ {I}_{ref}^{i} \}}_{i = 1}^{N}$$

and
corresponding target post digital images 110

$${\{ {P}_{ref}^{i} \}}_{i = 1}^{N}$$

(in which “N” is the reference number), the denoising UNet 118 is utilized to synthesize a novel-view digital video 106 guided by a target pose sequence

$${\{ {P}_{tgt}^{i} \}}_{j = 1}^{T}$$

in which “T” is a length of the target pose sequence. To do so, the digital video generation system 104 first processes each of the reference digital images 108 through the reference UNet “R” and CLIP encoder “C” (as an example of the clip encoder module 410) to extract the spatial reference features 408 and the semantic features 414, respectively. These features are subsequently fed into the denoising UNet 118 for generation of the digital video 106 using generative artificial intelligence (AI).

To identify informative regions of each reference digital image contributing to the target frames of the digital video 106, the pose correlation module 112 “H” is employed to compute pose correlation maps 114 based on a mapping of the reference poses and the target poses, which is utilized to identify which regions are relevant. Based on the pose correlation map 114, a filtering technique is employed that implements a reference selection technique to filter and forward reference features that are considered informative to subsequent network stages of the denoising UNet 118, thereby conserving computational resources.

As previously described, conventional digital video generations techniques utilize a single reference image to synthesize videos based on given pose signals. However, this conventional approach faces substantial technical challenges when handling dramatic viewpoint changes, as a single reference image often lacks sufficient visual content to cover sufficient appearance details.

To overcome these conventional technical challenges, the digital video generation system 104 is configured in one or more examples to leverage multiple reference digital images 108

$${\{ {I}_{ref}^{i} \}}_{i = 1}^{N}$$

from diverse viewpoints to aggregate a richer set of visual information, enhancing the quality and accuracy of the generation process. This enables the reference digital images 108 to provide comprehensive coverage of an object's appearance across various perspectives. At test time, given multiple reference digital images 108 as an input, the reference net module 404 (e.g., as reference U Net “R”) is used to extract a reference feature

$${\{ {F}_{l}^{i} \}}_{l = 1}^{L} = ℛ ( {I}_{ref}^{i} )$$

where “L” denotes a number of layers in the reference UNet “R” of the reference net module 404. The denoising UNet 118 then selects regions from the

$${\{ {F}_{l}^{i} \}}_{l = 1}^{L}$$

based on relevancy as indicated by the pose correlation map 114, which enhances quality in generation of the digital video 106.

Introduction of multiple reference digital images leads to a corresponding addition of redundant visual information, which increases computation and is a distraction to the denoising UNet 118. To mitigate against these technical challenges, the pose correlation module 112 as shown in FIG. 5 is employed to identify information regions in the reference digital images 108. The pose correlation module 112 does so by leveraging correlations between target poses of the digital images 110 and reference poses of the reference digital images 108.

To do so, the pose correlation module 112 includes a pose encoder 502 to encode a reference pose from the reference digital images 108 and a pose encoder 403 to encode a target pose from the target pose digital images 110. The encoded reference pose features 506 are then output by the pose encoder 502 and encoded target pose features 508 are output from the pose encoder 504. Expressed mathematically, given a target pose

$${P}_{tgt}^{t}$$

and a reference pose

$${P}_{r e f}^{i}$$

the two pose encoders 502, 504

$${E}_{r e f}^{P}$$

$${E}_{t g t}^{P}$$

with matching structures but do not share weights are used to extract reference and target pose features as follows:

$${F}_{ref}^{i} , {F}_{t g t}^{j} = {ℰ}_{r e f}^{P} ( {P}_{r e f}^{i} ) , {ℰ}_{t g t}^{P} ( {P}_{t g t}^{j} )$$

To capture a pose correlation map 114 “R^{i,j}” between the target pose and the reference pose, a transformer 510 is employed that includes a series of cross-attention layers. The target pose features 508

$${F}_{tgt}^{j}$$

serve as the key “Kₗ” and value “V” whereas the reference pose features 506

$${F}_{r e f}^{i}$$

acts as the query “Q” as follows:

$${R}^{i , j} = {f}_{z e r o} ∘ 𝒯 ( {W}_{q} {F}_{r e f}^{i} , {W}_{k} {F}_{t g t}^{j} , {W}_{v} {F}_{t g t}^{j} )$$

where “f_{zero}” which is depicted as zero conv 512 in FIG. 5 is a convolutional layer with zero-initialized weights to produce the pose correlation map 114. “T” represents the transformer 510 and “W_{q},” “Wₖ,” and “Wᵥ” are learnable parameters used to project the pose features.

Returning again to FIG. 4, the pose correlation map 114 is configurable as a set of pose correlation maps

$${\{ {R}^{i , j} \}}_{i = 1 , j = 1}^{N , T}$$

for each reference/target pose pair

$$( {P}_{r e f}^{i} ∈ {\{ {P}_{r e f}^{i} \}}_{i = 1}^{N} , {P}_{t g t}^{j} ∈ {\{ {P}_{t g t}^{j} \}}_{j = 1}^{T} ) .$$

After that, a fuse technique is employed by multiplying the “i^{th}” reference feature

$${F}_{j}^{i} ∈ {ℝ}^{{w}_{l} \times {h}_{l}} , l , … , L$$

with the pose correlation map 114 “R^{i,j}” at each layer “l” as follows:

$${F}_{c o r , 1}^{i , j} = {f}_{Inter} ( {R}^{i , j} ) \times {F}_{l}^{i}$$

where “fᵢₙₜₑᵣ” is a bilinear interpolation function that adjusts a size of the pose correlation map 114 “R^{i,j}” to match that of

$${F}_{l}^{i :}$$

at each respective “l-th” layer of the denoising UNet 118.

Subsequently, each of the emphasized features

$${F}_{c o r , l}^{i , j} , i ∈ [ 1 , N ]$$

are concatenated and provided as inputs into the denoising UNet 118 at respective layers of the machine-learning model 116. These features, for instance, are concatenated with intermediate latents of the denoising UNet 118 along a spatial dimension before being input into each spatial self-attention layer. This design allows the denoising UNet 118 to concentrate on information regions of the reference digital images 108 as indicated by the pose correlation map 114 and as such improve accuracy of novel viewpoint video synthesis in generating the digital video 106.

Feature manipulation as enabled through use of the pose correlation map 114 enables the denoising UNet 118 to focus on emphasized portions of the reference digital images 108. However, increasing a number of reference digital images 108 significantly raises the computational burden of the computing device 102, particularly during the iterative denoising process in the denoising UNet 118. Accordingly, in one or more examples the denoising UNet 118 is configured to employ a filtering technique that filters and passes visual features to the denoising UNet 118 based on an indicated relevance by the pose correlation map 114.

To synthesize a “j-th” frame, for instance, a set of pose correlation maps 114

$${\{ {R}^{i , j} \}}_{i = 1 , j = 1}^{N , T}$$

is computed from a target pose

$${P}_{tgt}^{j}$$

and each of the reference poses

$${\{ {P}_{ref}^{i} ∈ {ℝ}^{w \times h} \}}_{i = 1}^{N} ,$$

Each of the pose correlation maps from the set are flattened and concatenated as follows:

$${r}_{j} = {r}_{1 , j} ‖ {r}_{2 , j} ‖ … \vert \vert {r}_{N , j}$$

$${f}_{l} = {f}_{l}^{1} ‖ {f}_{l}^{2} ‖ … \vert \vert {f}_{l}^{N}$$

where “r_{i,j}∈ [symbol] ” with “n=wₗ×hₗ” represents a flattened correction map “{R^{i,j}}.” The symbol “∥” denotes a concatenation operator. Similarly, flattened references features “fₗ” are obtained from reference features

$${\{ {F}_{l}^{i} \}}_{i = 1}^{N} .$$

Reference features are select from “fₗ” based on how “informative” the features are toward frame generation based on correlation values “rⱼ.” For example, the correlation values “rⱼ” are sorted and a top “Kₗ” values at the “1-th” layer of the denoising UNet 118 are selected as follows:

$${f}_{l}^{{K}_{l}} = \{ {f}_{1}^{i} \vert i ∈ argsort ( {r}_{J} ) [ : {K}_{l} ] \} ,$$

$${r}_{j}^{{K}_{l}} = \{ {r}_{j}^{i} \vert i ∈ argsort ( {r}_{J} ) [ : {K}_{l} ] \} ,$$

where “argsort (rⱼ)” returns indices of “rⱼ” sorted in descending order. Using this technique, the top “Kₗ” reference features are fused with corresponding correlation values as follows:

$${f}_{cor , l}^{j} = {f}_{l}^{{K}_{i}} \times {r}_{j}^{{K}_{i}}$$

Consequently, the selected correlated features

$${f}_{cor , l}^{j}$$

are aggregated with the features of the denoising UNet 118 and passed to subsequent layers, e.g., spatial self-attention layer and temporal layer.

Strict reliance on top-K selection can lead the denoising UNet 118 to a local minimum during training, as the “argsort” operation is nondifferentiable. To encourage training towards a globally optimal solution, additional “Kₗ” reference features may be sampled uniformly from each of the reference features:

$${f}_{random , l}^{j} = {𝒮}_{uni} ( {f}_{l} , {K}_{l} )$$

The expression “Sᵤₙᵢ(·, Kₗ)” represents uniform sampling of “Kₗ” elements.” This allows the denoising UNet 118 to capture overall context with increased accuracy. By introducing uniform sampling, the pose correlation map 114

$${\{ {R}^{i , j} \}}_{i = 1 , j = 1}^{N , T}$$

and the pose correlation module 112 may be trained with a scattered gradient with increased stability.

During training, both

$${f}_{cor , l}^{j}$$

and

$${f}_{random , l}^{j}$$

are injected into the denoising UNet 118. During testing,

$${f}_{cor , l}^{j}$$

is used, solely, which encourages the denoising UNet 118 to focus on correlated regions and reduces a memory footprint thereby improving efficiency of computational resources.

In this way, the described pose correlation based digital video generation techniques address technical challenges in machine learning-based video generation by employing a diffusion machine-learning model that supports viewpoint changes and camera-to-object distance variations with improved accuracy and reduced visual artifacts. The digital video generation system 104 is configurable to generate a pose correlation map based on reference and target poses, which guides the model to selectively focus on relevant spatial locations in reference feature maps. This approach enables incorporation of visual information from multiple reference images without excessive computational costs, improving efficiency and enabling the generation temporally coherent digital videos with increased realism, particularly in scenarios involving significant viewpoint or distance changes that are challenging for conventional techniques.

FIG. 7 shows an example of a guided diffusion model 700 according to aspects of the present disclosure. In some examples, guided diffusion model 700 describes the operation and architecture of the machine-learning model 116 described with reference to FIG. 1.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 770 as input and apply forward diffusion process to gradually add noise to the original media item 705 to obtain noisy media item 720 at various noise levels.

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 765 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

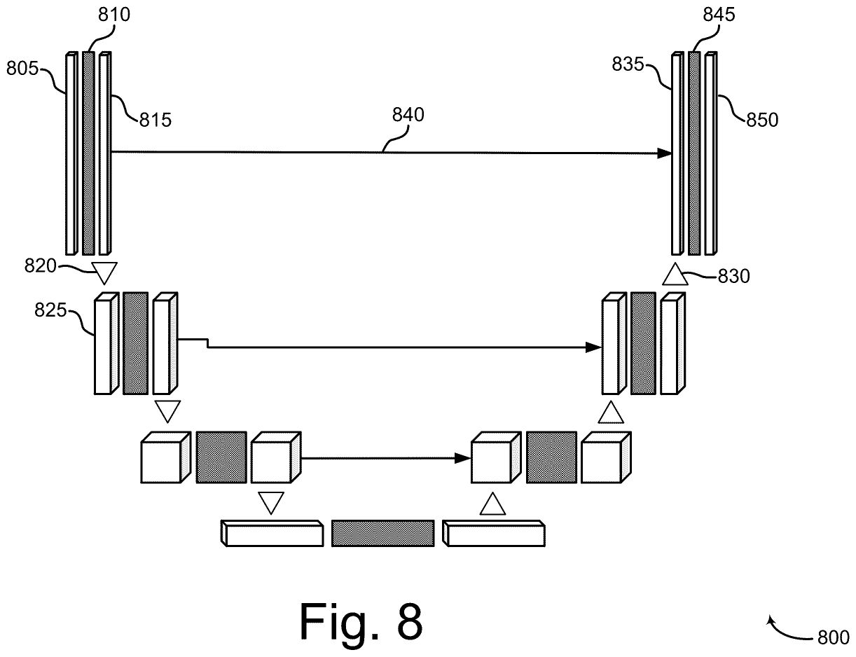

FIG. 8 shows an example of a U-Net 800 according to aspects of the present disclosure. In some examples, U-Net 800 is an example of the component that performs the reverse diffusion process 725 of a guided diffusion model 700 described with reference to FIG. 7. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 features have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815.

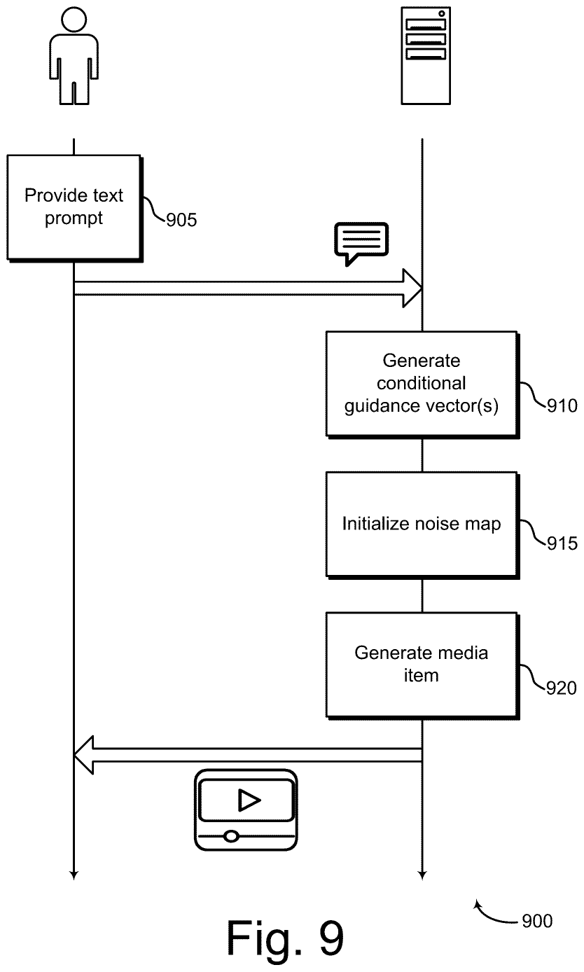

FIG. 9 shows an example of a method 900 for conditional media generation according to aspects of the present disclosure. In some examples, method 900 describes an operation of the model described with reference to FIG. 8 such as an application of the guided diffusion model 700 described with reference to FIG. 7. In some examples, these operations are performed by a system including a processor executing a set of codes to control functional elements of an apparatus.

Additionally or alternatively, operations of the method 900 may be performed using special-purpose hardware. Generally, these operations are performed according to the methods and processes described in accordance with aspects of the present disclosure. In some cases, the operations described herein are composed of various substeps or are performed in conjunction with other operations.

At operation 905, a user provides a text prompt describing content to be included in a generated media item. For example, a user may provide the prompt “a person playing with a cat”. In some examples, guidance can be provided in a form other than text, such as via an image, a sketch, or a layout.

At operation 910, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 915, a noise map is initialized that includes random noise. The noise map may be in a pixel space or a latent space. By initializing a media item with random noise, different variations of a media item including the content described by the conditional guidance can be generated.

At operation 920, the system generates a media item based on the noise map and the conditional guidance vector. For example, the media item may be generated using a reverse diffusion process as described with reference to FIG. 8.

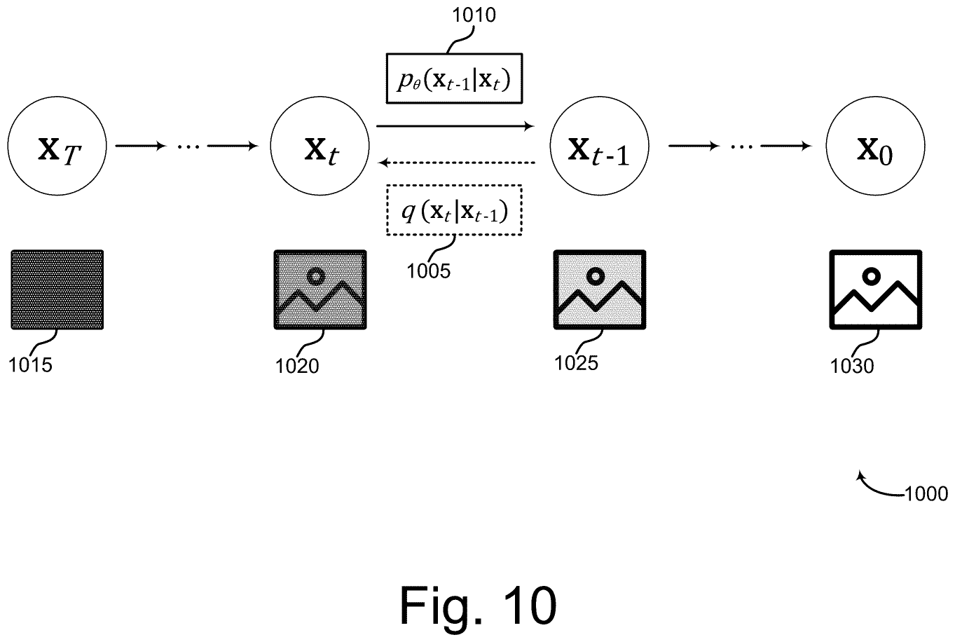

FIG. 10 shows a diffusion process 1000 according to aspects of the present disclosure. In some examples, diffusion process 1000 describes an operation of a diffusion model. As described above with reference to FIG. 7, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q (x_t|x_(t-1)), and the reverse diffusion process 1010 can be represented as p(x(t-1)|x_t). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x_0 (either in a pixel space or a latent space) intermediate variables x_1, . . . , x_T using a Markov chain. The Markov chain gradually adds Gaussian noise to the data to obtain the approximate posterior q (x_(1:T)|x_0) as the latent variables are passed through a neural network such as a U-Net, where x 1, . . . , x_T have the same dimensionality as x_0.

The neural network may be trained to perform the reverse process. During the reverse diffusion process 1010, the model begins with noisy data x_T, such as a noisy media item 1015 and denoises the data to obtain the p(x(t-1)|x_t). At each step t-1, the reverse diffusion process 1010 takes x_t, such as first intermediate media item 1020, and t as input. Here, t represents a step in the sequence of transitions associated with different noise levels, The reverse diffusion process 1010 outputs x_(t-1), such as second intermediate media item 1025 iteratively until x_T reverts back to x_0, the original media item 1030. The reverse process can be represented as:

$$p\_θ ( x\_ ( t - 1 ) \vert x\_t ) := N ( x\_ ( t - 1 ) ; µ\_θ ( x\_t , t ) , Σ\_θ ( x\_t , t ) ) . \qquad ( 1 )$$

The joint probability of a sequence of samples in the Markov chain can be written as a product of conditionals and the marginal probability:

$$x\_T : p\_θ ( x\_ ( 0 : T ) ) := p ( x\_T ) \prod \_ {( t = 1 )}^{\hat{}} Tp\_θ ( x\_ ( t - 1 ) \vert x\_t ) , \qquad ( 2 )$$

where p (x_T)=N(x_T;0,1) is the pure noise distribution as the reverse process takes the outcome of the forward process, a sample of pure noise, as input and Π_(t=1)\hat{ }T [symbol] [symbol] p_θ(x_(t-1)|x_t) [symbol] represents a sequence of Gaussian transitions corresponding to a sequence of addition of Gaussian noise to the sample.

At interference time, observed data x_0 in a pixel space can be mapped into a latent space as input and a generated data x is mapped back into the pixel space from the latent space as output. In some examples, x_0 represents an original input media item with low quality, latent variables x_1, . . . , x_T represent noisy media items, and x represents the generated item with high quality.

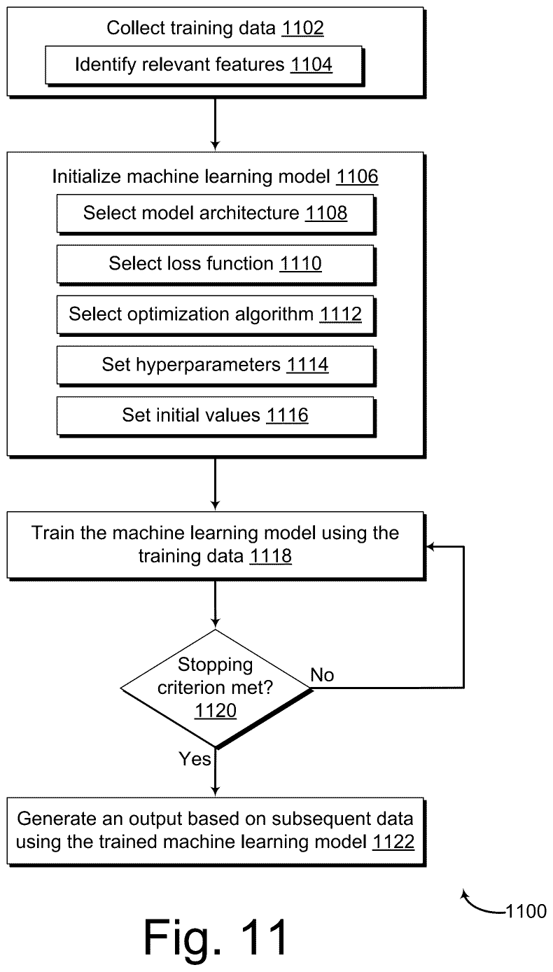

FIG. 11 is a flow diagram depicting an algorithm as a step-by-step procedure 1100 in an example implementation of operations performable for training a machine-learning model. In some implementations, the procedure 1100 describes an operation of the training component described for configuring a model as described with reference to FIG. 8. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

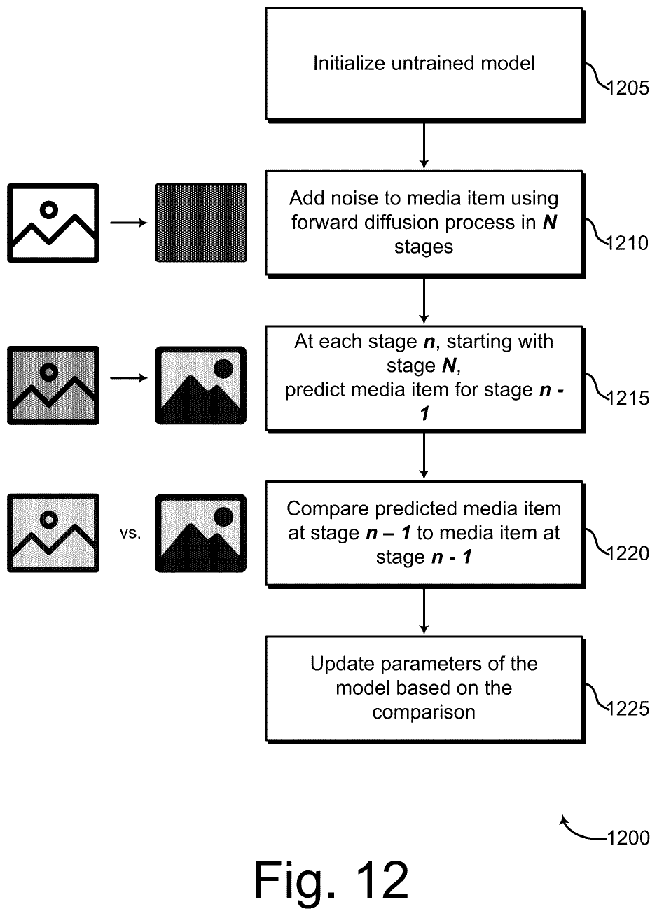

FIG. 12 shows an example of a method 1200 for training a diffusion model according to aspects of the present disclosure. In some embodiments, the method 1200 describes an operation of a training component as described in relation to FIG. 5. The method 1200 represents an example for training a reverse diffusion process as described above. In some examples, these operations are performed by a system including a processor executing a set of codes to control functional elements of an apparatus, such as a guided diffusion model.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1215, the system at each stage n, starting with stage N, a reverse diffusion process is used to predict the output or features at stage n-1. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares predicted output (or features) at stage n-1 to an actual media item (or features), such as the output at stage n-1 or the original input. For example, given observed data x, the diffusion model may be trained to minimize the variational upper bound of the negative log-likelihood-log [symbol] p_θ (x) of the training data.

At operation 1225, the system updates parameters of the model based on the comparison. For example, parameters of a U-Net may be updated using gradient descent. Time-dependent parameters of the Gaussian transitions can also be learned.

### Example System and Device

FIG. 13 illustrates an example system generally at 1300 that includes an example computing device 1302 that is representative of one or more computing systems and/or devices that implement the various techniques described herein. This is illustrated through inclusion of the digital audio generation system 104. The computing device 1302 is configurable, for example, as a server of a service provider, a device associated with a client (e.g., a client device), an on-chip system, and/or any other suitable computing device or computing system.

The example computing device 1302 as illustrated includes a processing device 1304, one or more computer-readable media 1306, and one or more I/O interface 1308 that are communicatively coupled, one to another. Although not shown, the computing device 1302 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1304 is representative of functionality to perform one or more operations using hardware. Accordingly, the processing device 1304 is illustrated as including hardware element 1310 that is configurable as processors, functional blocks, and so forth. This includes implementation in hardware as an application specific integrated circuit or other logic device formed using one or more semiconductors. The hardware elements 1310 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1306 is illustrated as including memory/storage 1312 that stores instructions that are executable to cause the processing device 1304 to perform operations. The computer-readable storage medium is configured for storing instructions that, responsive to execution by the processing device, causes the processing device to perform operations. The memory/storage 1312 represents memory/storage capacity associated with one or more computer-readable media. The memory/storage 1312 includes volatile media (such as random access memory (RAM)) and/or nonvolatile media (such as read only memory (ROM), Flash memory, optical disks, magnetic disks, and so forth). The memory/storage 1312 includes fixed media (e.g., RAM, ROM, a fixed hard drive, and so on) as well as removable media (e.g., Flash memory, a removable hard drive, an optical disc, and so forth). The computer-readable media 1306 is configurable in a variety of other ways as further described below.

Input/output interface(s) 1308 are representative of functionality to allow a user to enter commands and information to computing device 1302, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1302. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1302, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1310. The computing device 1302 is configured to implement particular instructions and/or functions corresponding to the software and/or hardware modules. Accordingly, implementation of a module that is executable by the computing device 1302 as software is achieved at least partially in hardware, e.g., through use of computer-readable storage media and/or hardware elements 1310 of the processing device 1304. The instructions and/or functions are executable/operable by one or more articles of manufacture (for example, one or more computing devices 1302 and/or processing devices 1304) to implement techniques, modules, and examples described herein.

The techniques described herein are supported by various configurations of the computing device 1302 and are not limited to the specific examples of the techniques described herein. This functionality is also implementable all or in part through use of a distributed system, such as over a “cloud” 1314 via a platform 1316 as described below.

The cloud 1314 includes and/or is representative of a platform 1316 for resources 1318. The platform 1316 abstracts underlying functionality of hardware (e.g., servers) and software resources of the cloud 1314. The resources 1318 include applications and/or data that can be utilized while computer processing is executed on servers that are remote from the computing device 1302. Resources 1318 can also include services provided over the Internet and/or through a subscriber network, such as a cellular or Wi-Fi network.

The platform 1316 abstracts resources and functions to connect the computing device 1302 with other computing devices. The platform 1316 also serves to abstract scaling of resources to provide a corresponding level of scale to encountered demand for the resources 1318 that are implemented via the platform 1316. Accordingly, in an interconnected device embodiment, implementation of functionality described herein is distributable throughout the system 1300. For example, the functionality is implementable in part on the computing device 1302 as well as via the platform 1316 that abstracts the functionality of the cloud 1314.

In implementations, the platform 1316 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, one or more digital images depicting a reference object and a target object;
extracting, using one or more machine-learning models, a reference feature and a target feature from the one or more digital images;
computing, using the one or more machine-learning models, a pose correlation map based on a reference pose of the reference object and a target pose of the target object from the one or more digital images;
generating, using the one or more machine-learning models, a digital video having a plurality of frames based on the reference feature, the target feature, and the pose correlation map; and
presenting, by the processing device, the digital video for display in a user interface.

2. The method as described in claim 1, wherein the reference feature includes a spatial reference feature of the reference object.

3. The method as described in claim 2, wherein the one or more machine-learning models used to extract the reference feature as the spatial reference features is configured in accordance with a UNet architecture.

4. The method as described in claim 1, wherein the target feature includes a semantic feature of the target object.

5. The method as described in claim 4, wherein the one or more machine-learning models used to extract the target feature as the semantic feature of the target object includes a contrastive language-image pretraining (CLIP) encoder.

6. The method as described in claim 1, wherein the generating of the digital video is performed by the one or more machine-learning models using a filtering technique that controls feature communication to subsequent stages of the one or more machine-learning models based on the pose correlation map.

7. The method as described in claim 1, wherein the one or more machine-learning models used to perform the generating of the digital video include a diffusion model as a denoising UNet.

8. The method as described in claim 1, wherein the digital video includes zooming a view of the reference object at a plurality of camera-to-object distances in the plurality of frames.

9. The method as described in claim 1, wherein the digital video includes panning a view of the reference object across a plurality of viewpoints in the plurality of frames.

10. A computing device comprising:
a processing device; and
a computer-readable storage medium storing instructions that, responsive to execution by the processing device, causes the processing device to perform operations including:
receiving a plurality of digital videos;
forming a plurality of segmented video clips by segmenting the plurality of digital videos;
generating a plurality of filtered video clips by filtering the plurality of segmented video clips using object detection by one or more machine-learning models;
forming training data including a plurality of training video clips by annotating poses of the plurality of filtered video clips by the one or more machine-learning models; and
training a diffusion machine-learning model based on the training data to generate a digital video.

11. The computing device as described in claim 10, wherein the plurality of digital videos are generated, respectively, using a single-camera setup.

12. The computing device as described in claim 10, wherein the plurality of digital videos include zooming a view of the human at a plurality of camera distances in a plurality of frames of the plurality of digital videos, respectively.

13. The computing device as described in claim 10, wherein the plurality of digital videos include panning a view of the human across a plurality of viewpoints in a plurality of frames of the plurality of digital videos, respectively.

14. The computing device as described in claim 10, wherein the diffusion machine-learning model is trained using the training data to generate the digital video based on a plurality of reference digital images depicting a reference object and a plurality of target pose digital images depicting a target motion of a target object

15. One or more computer-readable storage media storing instructions that, responsive to execution by a processing device, causes the processing device to perform operations including:
extracting, using one or more machine-learning models, a reference feature of a reference object and a target feature of a target object from one or more digital images;
computing, using the one or more machine-learning models, a pose correlation map based on a reference pose of the reference object and a target pose of the target object from the one or more digital images; and
generating, using the one or more machine-learning models, a digital video having a plurality of frames based on the reference feature, the target feature, and the pose correlation map using a filtering technique that controls feature communication to subsequent stages of the one or more machine-learning models based on the pose correlation map.

16. The one or more computer-readable storage media as described in claim 15, wherein the reference feature includes a spatial reference feature of the reference object.

17. The one or more computer-readable storage media as described in claim 15, wherein the target feature includes a semantic feature of the target object.

18. The one or more computer-readable storage media as described in claim 15, wherein the one or more machine-learning models used to perform the generating of the digital video include a diffusion model.

19. The one or more computer-readable storage media as described in claim 15, wherein the digital video includes zooming a view of the reference object at a plurality of camera-to-object distances in the plurality of frames.

20. The one or more computer-readable storage media as described in claim 15, wherein the digital video includes panning a view of the reference object across a plurality of viewpoints in the plurality of frames.
